(19) United States
(12) Patent Application Publication
(10) Pub. No.: US 2012/0301146 A1
(43) Pub. Date: Nov. 29, 2012

(54) Equivalent-Link Backward Propagation Method for Nonlinearity Compensation in Fiber Transmission Systems

(75) Inventors: Eduardo Mateo, Princeton, NJ (US); Fatih Yaman, Monmouth Junction, NJ (US)

(73) Assignee: NEC LABORATORIES AMERICA, INC., Princeton, NJ (US)

(21) Appl. No.: 13/480,900

(22) Filed: May 25, 2012

Related U.S. Application Data
(60) Provisional application No. 61/490,636, filed on May 27, 2011.

(51) Int. Cl. H04B 10/18; H04J 14/02; H04J 14/06

(52) U.S. Cl. 398/65; 398/147

(57) ABSTRACT

A method includes transmitting an optical signal over an optic link in a communication system, the optical link including an optical fiber and optical amplifier; coupling a coherent receiver in the communication system to the optic link for receiving the optical signal; and processing an output from the coherent receiver with digital signal processing DSP in the communication system, the DSP compensating for impairments of the optical signal due to the fiber optic link with an equivalent-link back-propagation.

### RELATED APPLICATION INFORMATION

This application claims priority to provisional application Ser. No. 61/490,636 filed on May 27, 2011, the contents thereof are incorporated herein by reference.

### BACKGROUND

The present invention relates to optics communications and, more particularly, to an equivalent-link backward propagation method for non-linearity compensation in fiber transmission systems.

In order to increase the fiber capacity two things have to be done: 1) Increase modulation order, and 2) Reduce channel spacing on WDM systems. For 1), a high optical-signal-to-noise-ratio OSNR is required, which translates into high optical power per channel. High power means high nonlinearity which distorts the optical signal. This is called intra-channel nonlinear distortion. For 2), reducing channel spacing yields to increased nonlinear cross-talk between WDM channels. This is called inter-channel nonlinear distortion.

From the above, fiber capacity is limited by the action of fiber nonlinearities. This invention proposes a method to compensate the nonlinear distortion, both intra- and inter-channel. Nonlinearity compensation allows increase either transmission capacity (for a give transmission distance) or transmission distance (for a given transmission capacity).

Other techniques have been used to compensate for nonlinearities in fiber transmission: 1) Optical phase conjugation, 2) Digital Backward Propagation (or back-propagation)

The optical phase conjugation method consists of performing optical phase conjugation in the middle of the transmission link. If the link has certain symmetry properties, the second half of the link compensates the nonlinear distortion created in the first half. Optical phase conjugation can be implemented in the optical domain or in the electrical domain. This technique presents the following: i) Typical transmission link are non-symmetric and ii) Implementation of optical phase conjugation requires cumbersome optical set-up.

The Digital Backward Propagation (or Back-propagation or hereafter BP) technique compensates fiber impairments (including nonlinearity) in the digital domain. This technique involves the following steps:
a. Coherent detection of the optical signal: This step allows to recover both amplitude and phase
b. Analog-to-digital conversion: This step creates a digital version of the detected signal
c. Signal reconstruction: This step creates a digital version of the optical field at the end of the fiber
d. Back-propagation: This step takes the signal in c. and simulates optical propagation with negative parameters (i.e. backwards). This step involves:
   d. 1. Knowledge of the fiber characteristics, namely: Dispersion parameter(s), nonlinear coefficient, distance(s) between amplifiers, gain of the amplifiers, fiber loss, input power.
   d. 2. Solve the BP-equations with the above parameters. This is typically done using the so-called split step method. This method consists on dividing the transmission in multiple steps. The amount of steps depends on how fast the optical field changes along the link.

The BP technique has the following limitations: i) Knowledge of all the physical parameters of the transmission link and ii) Solution of the BP equations is very complex and it requires a large number of steps.

Accordingly, there is a need to for a method for compensation for nonlinear impairments in optical fiber transmission that is superior to the above known compensation techniques.

### SUMMARY

A method includes transmitting an optical signal over an optic link in a communication system, the optical link including an optical fiber and optical amplifier; coupling a coherent receiver in the communication system to the optic link for receiving the optical signal; and processing an output from the coherent receiver with digital signal processing DSP in the communication system, the DSP compensating for impairments of the optical signal due to the fiber optic link with an equivalent-link back-propagation. In a preferred embodiment, the equivalent-link back-propagation uses equivalent link parameters corresponding to an equivalent link, the equivalent link parameters include a dispersion pre-compensation equivalent link parameter, a dispersion compensation equivalent link parameter, and a dispersion post-compensation equivalent link parameter, the values for the equivalent link parameters being obtained for a given number of steps N and are those that give a maximum Q-factor of the optical signal, and using these equivalent link parameters for reducing number of the steps N thereby reducing complexity of the DSP compensating.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of an exemplary optical communication system, with coherent detection and digital signal processing DSP, in which the invention can be practiced.

FIG. 2 is a block diagram showing exemplary DSP stages.

FIG. 3 is a diagram of Equivalent-Link Backward Propagation, in accordance with the invention.

### DETAILED DESCRIPTION OF PREFERRED EMBODIMENTS

The present invention is directed to a method for compensating for nonlinear impairments in optical fiber transmission by using an efficient method to implement Back-propagation (described above in general aspects). This invention consists of reducing the complexity of Back-propagation.

In conventional BP, the number of steps required to solve the BP-equations is limited by the variations of the physical link. As an example, in a link where the dispersion parameter changes every 50 km, the step size for BP has to be equal of smaller than 50 km to successfully compensate nonlinear effects. Therefore, if the total link is 4000 km, conventional-BP requires at least 4000/50=80 steps.

This invention consists of implementing BP on an equivalent” link. This equivalent link is described by optimized parameters. This new technique, hereafter “Equivalent-link Back-Propagation” (EqBP) has these two fundamental features:
A. Does not require knowledge of the real link parameters. The EqBP Just approximate values of some of them to speed up the optimization process.
B. The EqBP requires much less number of steps while providing almost the same nonlinear compensation than conventional BP.

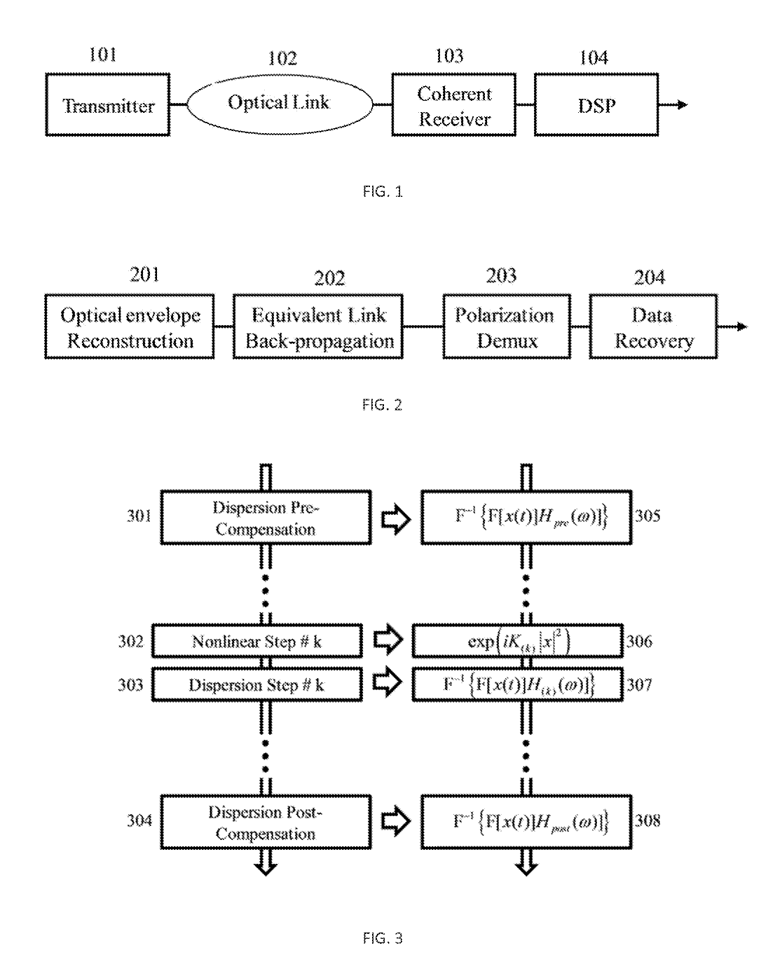

Referring now in detail to the figures in which like numerals represent the same or similar elements and initially to FIG. 1, is a diagram of an exemplary optical communication system, with coherent detection and digital signal processing, in which the inventive equivalent-link back-propagation can be practiced. The optical transmitter 101 is coupled to a coherent receiver 103 over an optical link 102. The optical comprises optical fibers and optical amplifiers such as EDFA, Raman or both. Output from the coherent receiver 103 is coupled to digital signal processing 204.

The stages of the DSP 104 of FIG. 1 are shown in the block diagram of FIG. 2. In an optical reconstruction stage 201, the outputs of the coherent receiver are combined to create a digital copy of the received optical envelope. The equivalent-link back-propagation stage 202 performs back-propagation over an equivalent link (see FIG. 3). Output from the EQBP 202 is subjected to a polarization de-multiplexing stage 203 for the subsequent data recover stage.

Referring now to the block diagram of FIG. 3, there is shown the implementation steps for the inventive equivalent-link BP in digital signal processing, where k=[1 . . . N], x is the incoming signal, F is Fourier Transform and F⁻¹ is inverse Fourier Transform. The above steps are performed using the parameters Hₚᵣₑ, Hₚₒₛₜ, K₍ₖ₎ and H₍ₖ₎ corresponding to the equivalent link. These values are obtained for a given number of steps N and are those that give the maximum Q-factor of the signal. By using these equivalent link parameters, the number of steps N can be drastically reduced and so is the complexity.

Initially, a dispersion pre-compensation step 301 is carried out based on block 305: F⁻¹{F[x(t)]Hₚᵣₑ(ω)]}. Then a nonlinear step 302 for performing phase rotation is carried out based on block 306: exp(iK₍ₖ₎|x|²). A dispersion step 303 follows, wherein dispersion compensation is carried out based on block 307: F⁻¹{F[x(t)]H₍ₖ₎(ω)]}. Following step 303, a dispersion post-compensation step 304 is carried out based on block 308: F⁻¹{F[x(t)]Hₚₒₛₜ(ω)]}.

From the above it can be seen that the present invention is advantageous in that it is less complex and a substantial improvement over known techniques for non-linear compensation in optical transmission. This invention provides a solution to the well-known complexity problem of conventional back-propagation. By significantly reducing the number of steps, the inventive Equivalent-Link BP can be now implemented in current DSP chips. This superior implementation capability also provides faster operation and lower cost.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method comprising the steps of:
transmitting an optical signal over an optic link in a communication system, said optical link including an optical fiber and optical amplifier;
coupling a coherent receiver in said communication system to said optic link for receiving said optical signal; and
processing an output from said coherent receiver with digital signal processing DSP in said communication system, said DSP compensating for impairments of said optical signal due to said fiber optic link with an equivalent-link back-propagation.

2. The method of claim 1, wherein said equivalent-link back-propagation comprises using equivalent link parameters corresponding to an equivalent link, said equivalent link parameters including a dispersion pre-compensation equivalent link parameter, a dispersion compensation equivalent link parameter, and a dispersion post-compensation equivalent link parameter, the values for said equivalent link parameters being obtained for a given number of steps N and are those that give a maximum Q-factor of said optical signal, and using these equivalent link parameters for reducing number of said steps N thereby reducing complexity of said DSP compensating.

3. The method of claim 2, wherein said equivalent-link back-propagation comprises:
i) Performing a dispersion pre-compensation on said optical signal x,
ii) performing a non-linear step of phase rotation on an output from said dispersion pre-compensation,
iii) performing a dispersion compensation step on an output from said non-linear step, and
iv) performing dispersion post-compensation on an output from said dispersion compensation step,

4. The method of claim 3, wherein said dispersion pre-compensation step i) is carried out based on F⁻¹ {F[x(t)]Hₚᵣₑ(ω)]}, where k=1 . . . N], x is an incoming signal, F is Fourier Transform and F⁻¹ is inverse Fourier Transform, and Hₚᵣₑ is said dispersion pre-compensation equivalent link parameter.

5. The method of claim 3, wherein said nonlinear step ii) is carried out based exp(iK₍ₖ₎|x|²), where k=[1 . . . N], and x is an incoming signal.

6. The method of claim 3, wherein said dispersion compensation step iii) is carried out based on F⁻¹{F[x(t)]H₍ₖ₎ (ω)]}, where k=[1 . . . N], x is an incoming signal, F is Fourier Transform and F⁻¹ is inverse Fourier Transform, and H₍ₖ₎ is said dispersion compensation equivalent link parameter.

7. The method of claim 6, wherein said dispersion post-compensation step iv) is carried out based on F⁻¹{F[x(t)]Hₚₒₛₜ (ω)]}, where k=[1 . . . N], x is an incoming F is Fourier ‘Transform and F⁻¹ is inverse Fourier Transform, and H₍ₚₒₛₜ₎ is said dispersion post-compensation equivalent link parameter.

8. The method of claim 1, wherein said communication system comprises wavelength-division multiplexing and polarization-division multiplexing.

9. The method of claim 1, wherein said DSP performs nonlinearity compensation.

10. The method of claim 1, wherein said optic link includes a number of fiber sections of arbitrary lengths and properties and a number of optical amplifiers located at arbitrary points of said optic link.

11. The method of claim 3, wherein said equivalent link parameters Hₚᵣₑ, Hₚₒₛₜ, Kₙ₁ and H_{fiber} are ones providing a best performance for a given number of N stages.

12. The method of claim 3, wherein H_{fiber} is different for each stage N.

13. The method of claim 3, wherein Kₙₗ is different for each stage N.

14. The method of claim 1, wherein said DSP comprises a nonlinearity-compensation stage and said DSP being a process for solving backward propagation equations of an equivalent link to said optic link.
